(19) United States
(12) Patent Application Publication
(10) Pub. No.: US 2014/0088868 A1
(43) Pub. Date: Mar. 27, 2014

(54) ELECTRONIC DEVICE AND METHOD FOR VEHICLE NAVIGATION

(71) Applicant: HON HAI PRECISION INDUSTRY CO., LTD., New Taipei (TW)

(72) Inventor: YUH-SHYING GAU, New Taipei (TW)

(73) Assignee: HON HAI PRECISION INDUSTRY CO., LTD., New Taipei (TW)

(21) Appl. No.: 14/016,155

(22) Filed: Sep. 2, 2013

(30) Foreign Application Priority Data
Sep. 26, 2012 (TW) 101135200

(51) Int. Cl. G01C 21/34

(52) U.S. Cl. CPC G01C 21/34
USPC 701/527; 701/533

(57) ABSTRACT

An electronic device is connected to a cloud server. The cloud server stores an estimate time of a vehicle for passing each road during different periods. When a user selects a start position and a destination position, the electronic device calculates a shortest path from the start position to the destination position. The electronic device reads an estimate time for passing each road corresponding to a system time of the electronic device. A path that the vehicle spends least time from the start position to the destination position is selected according to the estimate time for passing each road of the selected path. When the vehicle has arrived at the destination position, the electronic device uploads the selected path and a time of passing each road of the selected path.

### BACKGROUND

1. Technical Field

Embodiments of the present disclosure relate to vehicle management technology, and more particularly to an electronic device and a method for vehicle navigation.

2. Description of Related Art

A global positioning navigation system (GPS) is convenient for helping a user navigate unfamiliar roads or reach unfamiliar destination. However, if there are errors in the GPS information, a vehicle may take the wrong road or not get to the correct destination. Thus, the user may miss an important appointment and could even become lost.

### BRIEF DESCRIPTION OF THE DRAWINGS

FIG. 1 is a block diagram of one embodiment of an electronic device including a navigation system.

FIG. 2 is a block diagram of one embodiment of function modules of the navigation system in FIG. 1.

FIG. 3 is a flowchart of one embodiment of a method for vehicle navigation.

FIG. 4 is a schematic diagram illustrating one embodiment of a travel path.

FIG. 5 is a table illustrating one embodiment of navigation icons.

FIG. 6 is a table illustrating another embodiment of navigation icons.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language. One or more software instructions in the modules may be embedded in firmware, such as in an erasable programmable read only memory (EPROM). The modules described herein may be implemented as either software and/or hardware modules and may be stored in any type of non-transitory computer-readable medium or other storage system. Some non-limiting examples of non-transitory computer-readable media include CDs, DVDs, BLU-RAY, flash memory, and hard disk drives.

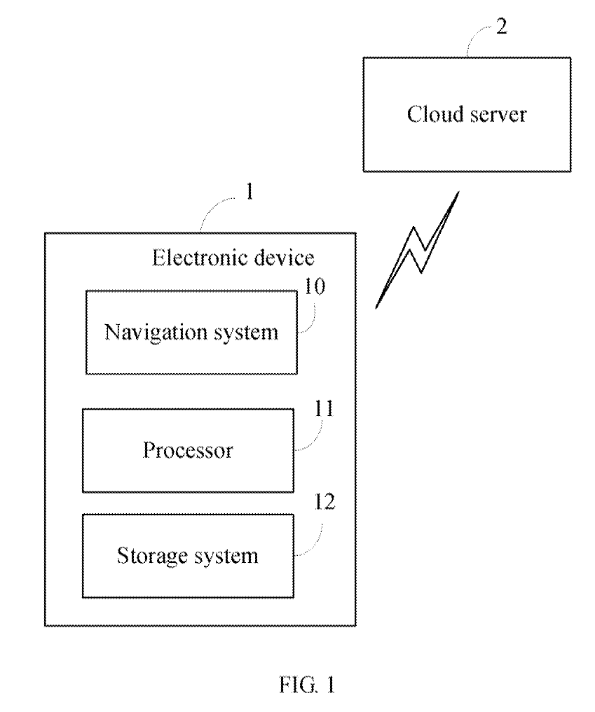

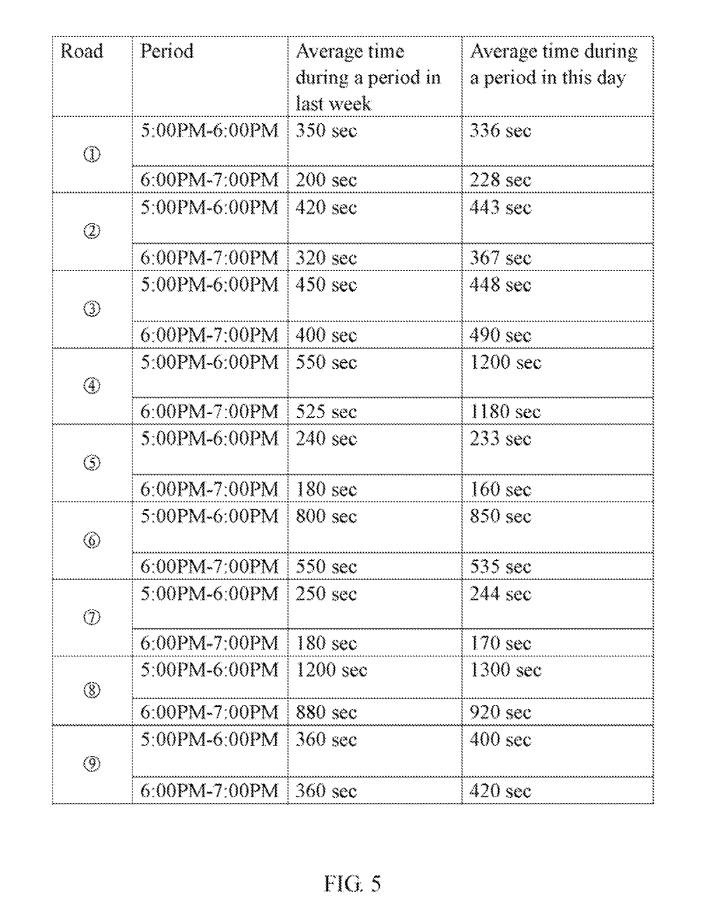

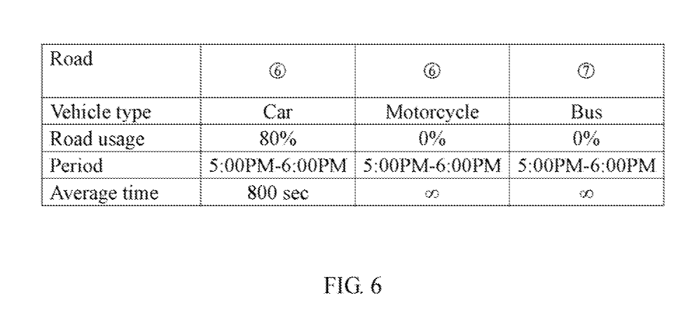

FIG. 1 is a block diagram of one embodiment of an electronic device 1 including a navigation system 10, a processor 11, and a storage system 12. The electronic device 1 may be a mobile phone, for example. The electronic device 1 is connected to a cloud server 2. The cloud server 2 stores an estimate time that a vehicle spent on passing through each road during different periods. The periods can be determined every hour. For example, the periods may include 5:00 am˜6:00 am and 6:00 am˜7:00 am. In one embodiment, the estimate time for passing through a road may be an average time spent by all vehicles on passing through the road during a period in a day, a week, or a month, as shown in FIG. 5. As shown in FIG. 6, the cloud server 2 stores a road usage of each vehicle type on each road. The road usage of a vehicle type of a road in a period is a ratio of a number of vehicles of the vehicle type and a number of all vehicles passing the road in the period. The usage of a road “0%” may denote that the vehicle type is forbidden to go through on the road.

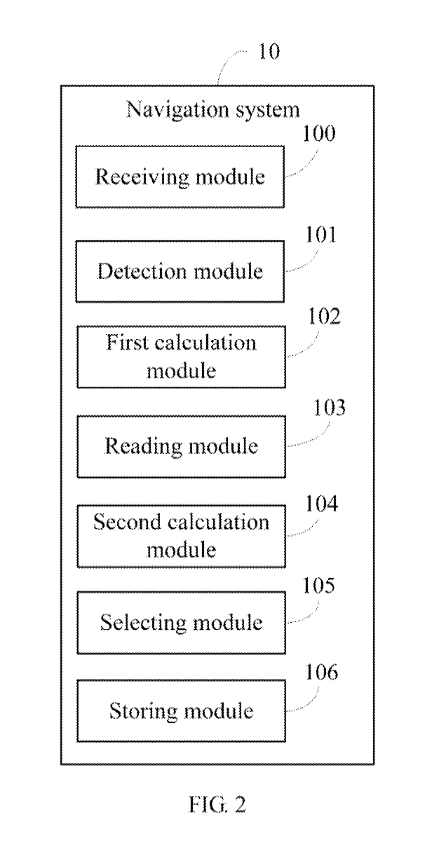

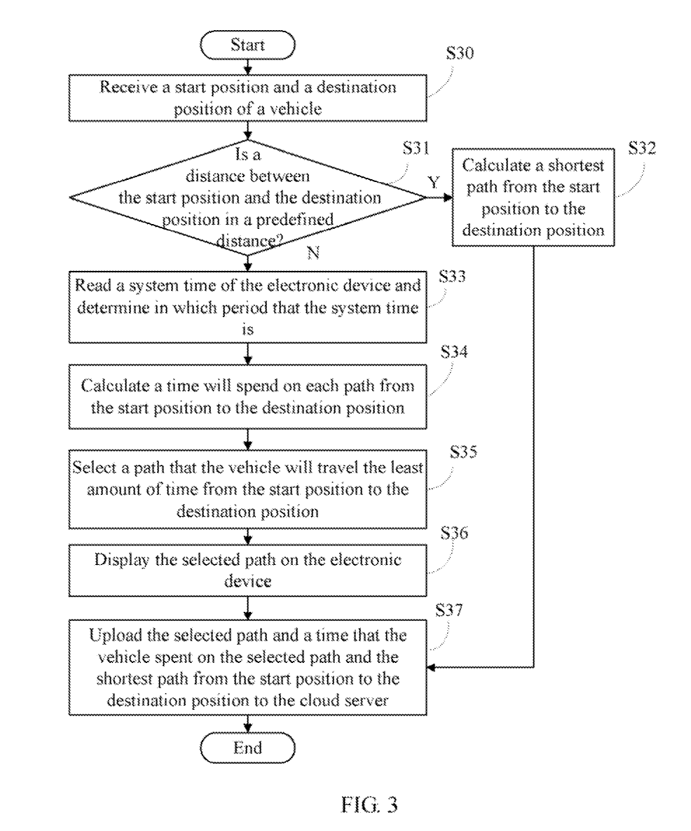

As shown in FIG. 2, the navigation system 10 includes a plurality of function modules, such as a receiving module 100, a detecting module 101, a first calculation module 102, a reading module 103, a second calculation module 104, a selecting module 105, and a storing module 106. The modules 100-106 include computerized code in the form of one or more programs that are stored in the storage system 12. The computerized code includes instructions that are executed by the processor 11, to provide aforementioned functions of the navigation system 10. Detailed functions of the modules 100-106 are given in reference to FIG. 3.

FIG. 3 is a flowchart of one embodiment of a method for vehicle navigation. Depending on the embodiment, additional steps may be added, others removed, and the ordering of the steps may be changed.

In step S30, the receiving module 100 receives a start position and a destination position of a vehicle set by a user of the electronic device 1. In one embodiment, the receiving module 100 can receive the start position and the destination position of the vehicle by receiving a voice of a user.

In step S31, the detecting module 101 detects whether a distance between the start position and the destination position is within a predefined distance. When the distance between the start position and the destination position is in the predefined distance, the start position and the destination position are considered to be in a same area. In one embodiment, the predefined distance is 2 km. If the distance between the start position and the destination position is in the predefined distance, step S32 is implemented. If the distance between the start position and the destination position is not in the predefined distance, step S33 is implemented.

In step S32, the first calculation module 102 calculates a shortest path from the start position to the destination position, then step S37 is implemented directly. In one embodiment, the shortest path can be calculated by using a Dijkstra method.

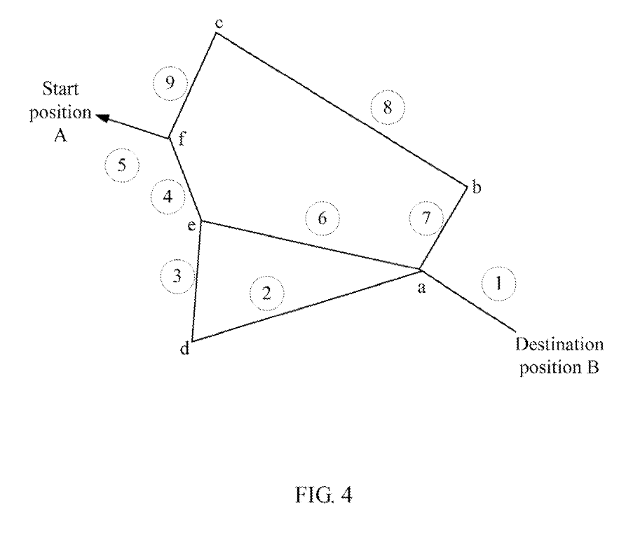

In step S33, the reading module 103 reads a system time of the electronic device 1, and determines which period that the system time falls within. Then the reading module 103 reads an estimate time corresponding to the determined period of all the roads from the start position to the destination position. For example, as shown in FIG. 4, the start position is a point “A” and the destination position is a point “B.” There are three paths from the point “A” to the point “B”. The three paths are \textcircled{1}\textcircled{2}\textcircled{3}\textcircled{4}\textcircled{5} [symbol] \textcircled{1}\textcircled{6}\textcircled{4}\textcircled{5} [symbol] \textcircled{1}\textcircled{7}\textcircled{8}\textcircled{9}\textcircled{5}. The path \textcircled{1}\textcircled{2}\textcircled{3}\textcircled{4}\textcircled{5} includes a road A-a, a road a-d, a road d-e, a road e-f, and a road f-B. The path \textcircled{1}\textcircled{6}\textcircled{4}\textcircled{5} includes a road A-a, a road a-b, a road b-c, a road c-f, and a road f-B. The path \textcircled{1}\textcircled{7}\textcircled{8}\textcircled{9}\textcircled{5} includes a road A-a, a road a-b, a road b-c, a road c-f, and a road f-B. The estimate time corresponding to the determined period of all the roads from the point “A” to the point “B” is shown in FIG. 5.

In step S34, the second calculation module 104 calculates a time that the vehicle will spend on each path from the start position to the destination position according to the read estimate time of each road. The time that the vehicle will spend on a path from the start position to the destination position is a sum of the estimate times for passing through all the roads of the path. As shown in FIG. 5, when the system time of the electronic device 1 is in a period 5:00 am˜6:00 am, the time that the vehicle will spend on the path \textcircled{1}\textcircled{6}\textcircled{4}\textcircled{5} is 1940s, the time that the vehicle will spend on path \textcircled{1}\textcircled{2}\textcircled{3}\textcircled{4}\textcircled{5} is 2010s, and the time that the vehicle will spend on path \textcircled{1}\textcircled{7}\textcircled{8}\textcircled{9}\textcircled{5} is 2400s.

In step S35, the selecting module 105 selects a path that the vehicle will travel the least amount of time from the start position to the destination position according to the calculated time of each path. As shown in FIG. 4 and FIG. 5, the path \textcircled{1}\textcircled{6}\textcircled{4}\textcircled{5} is selected during the period 5:00 am˜6:00 am.

In step S36, the selecting module 105 displays the selected path on the electronic device 1.

In step S37, when the vehicle has arrived at the destination position, the storing module 106 uploads the selected path, a time that the vehicle spent on each road of the selected path, and the shortest path from the start position to the destination position to the cloud server 2.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device, comprising:
a processor; and
a non-transitory computer-readable medium that stores one or more programs, which comprise instructions which when executed by the processor of the electronic device, performs operations of:
(a) receive a start position and a destination position of a vehicle set by a user of the electronic device;
(b) read a system time of the electronic device, determining which period that the system time falls within, and read an estimate time for passing through all roads corresponding to the determined period from the start position to the destination position;
(c) calculate a time that the vehicle will spend on each path from the start position to the destination position according to the read estimate time for passing each road of each path; and
(d) select a path on which the vehicle will travel the least amount of time from the start position to the destination position according to the calculated time of each path, and display the selected path on the electronic device.

2. The electronic device as claimed in claim 1, wherein the operations further comprise:
detect whether a distance between the start position and the destination position is within a predefined distance;
execute the operation (c) when the distance between the start position and the destination position is within a predefined distance; and
calculate a shortest path from the start position to the destination position when the distance between the start position and the destination position is not within a predefined distance.

3. The electronic device as claimed in claim 1, wherein the operations further comprise:
upload the selected path and ,a time that the vehicle spent on the selected path to the cloud server.

4. The electronic device as claimed in claim 1, wherein the time that the vehicle will spend on of a path from the start position to the destination position is a sum of the estimate times for passing all the roads of the path.

5. A method being executed by a processor of an electronic device, comprising steps:
(a) receiving a start position and a destination position of a vehicle set by a user of the electronic device;
(b) reading a system time of the electronic device, determining which period that the system time falls within, and reading an estimate time for passing through all roads corresponding to the determined period from the start position to the destination position;
(c) calculating a time that the vehicle will spend on each path from the start position to the destination position according to the read estimate time for passing each road of each path; and
(d) selecting a path on which the vehicle will travel the least amount of time from the start position to the destination position according to the calculated time of each path, and displaying the selected path on the electronic device.

6. The method as claimed in claim 5, wherein the method further comprises:
detecting whether a distance between the start position and the destination position is within a predefined distance;
executing the step (c) when the distance between the start position and the destination position is within a predefined distance; and
calculating a shortest path from the start position to the destination position when the distance between the start position and the destination position is not within a predefined distance.

7. The method as claimed in claim 5, wherein the method further comprising:
uploading the selected path and , a time that the vehicle spent on the selected path to the cloud server.

8. The method as claimed in claim 5, wherein the time that the vehicle will spend on of a path from the start position to the destination position is a sum of the estimate times for passing all the roads of the path.

9. A non-transitory computer-readable medium having stored thereon instructions that, when executed by a processor of an electronic device, cause the processor to perform operations of:
(a) receiving a start position and a destination position of a vehicle set by a user of the electronic device;
(b) reading a system time of the electronic device, determining which period that the system time falls within, and reading an estimate time for passing through all roads corresponding to the determined period from the start position to the destination position;
(c) calculating a time that the vehicle will spend on each path from the start position to the destination position according to the read estimate time for passing each road of each path; and
(d) selecting a path on which the vehicle will travel the least amount of time from the start position to the destination position according to the calculated time of each path, and displaying the selected path on the electronic device.

10. The non-transitory computer-readable medium as claimed in claim 9, wherein the method further comprises:
detecting whether a distance between the start position and the destination position is within a predefined distance;
executing the step (c) when the distance between the start position and the destination position is within a predefined distance; and
calculating a shortest path from the start position to the destination position when the distance between the start position and the destination position is not within a predefined distance.

11. The non-transitory computer-readable medium as claimed in claim 9, wherein the method further comprising:
uploading the selected path and , a time that the vehicle spent on the selected path to the cloud server.

12. The non-transitory computer-readable medium as claimed in claim 9, wherein the time that the vehicle will spend on of a path from the start position to the destination position is a sum of the estimate times for passing all the roads of the path.
